(19) United States
(12) Patent Application Publication
(10) Pub. No.: US 2007/0278055 A1
(43) Pub. Date: Dec. 6, 2007

(54) Adjustable disc brake assembly for a bicycle

(76) Inventor: Jui-Pin Chen, Changhua City (TW)

Correspondence Address: COOPER & DUNHAM, LLP, 1185 AVENUE OF THE AMERICAS, NEW YORK, NY, 10036, US

(21) Appl. No.: 11/443,949

(22) Filed: May 31, 2006

(51) Int. Cl. F16D 65/14

(52) U.S. Cl. 188/2 D

(57) ABSTRACT

An adjustable disc brake assembly on a bicycle having a frame and a rear wheel with a rear axle is attached to the frame and the rear wheel and has a mounting bracket, a brake alignment device and a disc brake. The mounting bracket is attached to the frame and has an elongated dropout, a lower elongated slot and an upper elongated slot. The brake alignment device is mounted on the rear axle and has a mounting hole and a connecting hole. The mounting hole is formed through the brake alignment device and is mounted around the rear axle. The connecting hole is formed through the brake alignment device above the mounting hole and aligns with one of the elongated slots. The disc brake is attached slidably to the mounting bracket and securely to the rear wheel and has a caliper, an upper bolt, a lower bolt and a rotor.

### BACKGROUND OF THE INVENTION

1. Field of the Invention

The present invention relates to a disc brake assembly, and more particularly to an adjustable disc brake assembly for a bicycle that adjusts a disc brake rotor and caliper synchronously.

2. Description of Related Art

A conventional disc brake for a bicycle having a frame with a rear, a front fork, a front wheel mounted in the front fork, a chain and a rear wheel mounted in an elongated dropout at the rear of the frame to adjust tension on the chain is usually mounted on the front fork and front wheel because the relative position of the front fork and front wheel do not change and comprises a caliper and a rotor. The caliper is mounted on the front fork or the frame near the rear and has two brake pads and two pistons. The brake pads face each other.

The pistons press the brake pads together when the disc brake is activated. The rotor is attached concentrically to the front wheel or rear wheel corresponding to the caliper and is mounted between the brake pads in the caliper. Activating the disc brake causes the brake pads to squeeze the rotor and slow or stop the rotation of the front wheel. However, moving the rear wheel in the elongated dropout to tighten the chain causes the rotor to misalign with the caliper and the brake pads and keeps the disc brake from operating efficiently.

Therefore, an adjustable disc brake assembly for a bicycle is required, which can simultaneously adjust the caliper and the rotor so they stay in proper alignment and the disc brake will operate properly.

### SUMMARY OF THE INVENTION

The main objective of the present invention is to provide an adjustable disc brake assembly for a bicycle with a rear wheel, which maintains alignment of the disc brake when the rear wheel of the bicycle is adjusted.

The adjustable disc brake assembly on a bicycle having a frame and a rear wheel with a rear axle is attached to the frame and the rear wheel and comprises a mounting bracket, a brake alignment device and a disc brake. The mounting bracket is attached securely to the frame and has an elongated dropout, a lower elongated slot and an upper elongated slot. The brake alignment device is mounted on the rear axle and has a mounting hole and a connecting hole. The mounting hole is formed through the brake alignment device and is mounted around the rear axle. The connecting hole is formed through the brake alignment device above the mounting hole and aligns with one of the elongated slots. The disc brake is attached slidably to the mounting bracket and securely to the rear wheel and has a caliper, an upper bolt, a lower bolt and a rotor.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an adjustable disc brake assembly in accordance with the present invention on a rear wheel of a bicycle;

FIG. 2 is a side view of the adjustable disc brake assembly in FIG. 1;

FIG. 3 is an operational side view of the adjustable disc brake assembly in FIG. 1 when the rear wheel is adjusted; and

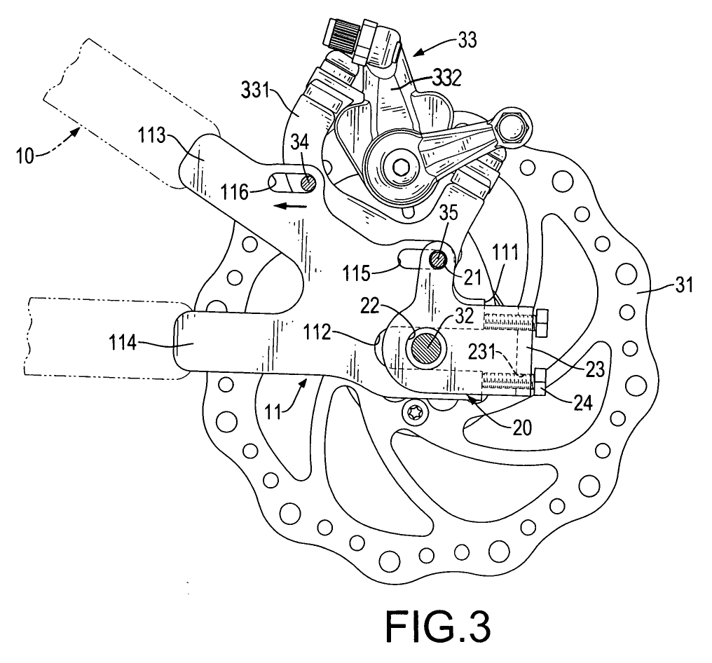

FIG. 4 is another embodiment of an adjustable disc brake assembly in accordance with the present invention.

### DETAILED DESCRIPTION OF THE PREFERRED EMBODIMENT

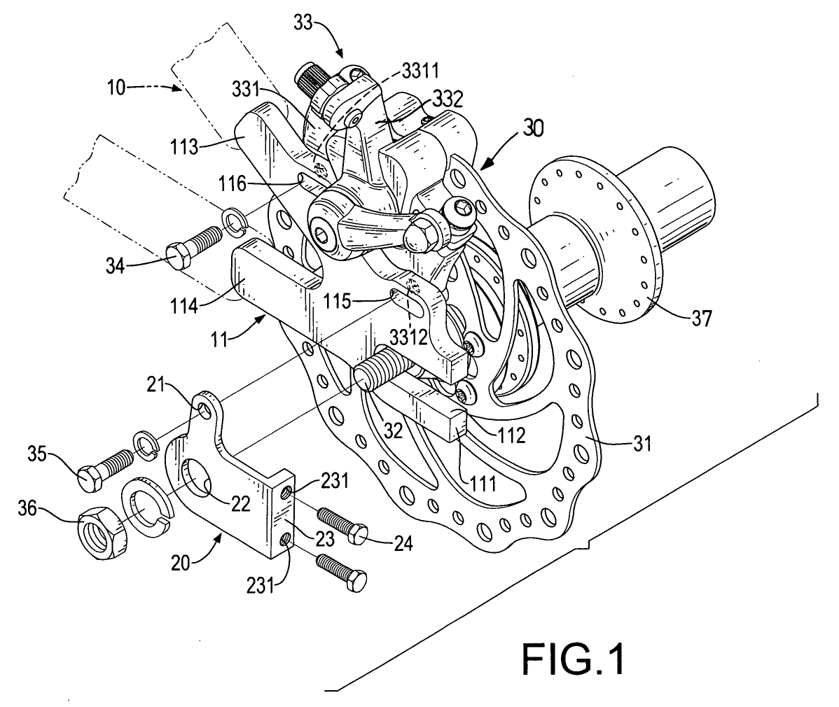

With reference to FIGS. 1, 2 and 4, an adjustable disc brake assembly in accordance with the present invention for a bicycle having a frame (10) with an upper tube and a lower tube and a rear wheel with a rear axle (32) to connect the rear wheel to the frame (10), a hub (37) mounted rotatably on the rear axle (32) and having two ends and two axle nuts (36) screwed respectively onto the ends of the rear axle to hold the rear wheel on the frame (10) comprises a mounting bracket (11), a brake alignment device (20, 20A) and a disc brake (30).

The mounting bracket (11) is attached to the frame (10), holds one end of the rear axle (32) and has a front end, a rear end, an inner surface, an outer surface, an upper arm (113), a lower arm (114), a drive surface (111), an elongated dropout (112), a lower elongated slot (115) and an upper elongated slot (116).

The upper arm (113) may be rectangular, is formed on and protrudes up at an angle up from the front end of the mounting bracket (11) and is attached securely to the upper tube of the frame (10).

The lower arm (114) may be rectangular, is formed on and protrudes longitudinally from the front end of the mounting bracket (11) below the upper arm (113) and is attached securely to the lower tube of the frame (10).

The drive surface (111) is defined on the rear end of the mounting bracket (11).

The elongated dropout (112) is formed horizontally through the drive surface (111) of the mounting bracket (11), communicates with the rear end of the mounting bracket (11), holds the rear axle (32) and has a closed front end and an open rear end. The lower elongated slot (115) is formed through the mounting bracket (11) above and parallel to the elongated dropout (112).

The upper elongated slot (116) is formed through the upper arm (113) parallel to the elongated dropout (112).

The brake alignment device (20, 20A) is mounted around the rear axle (32), may press against the drive surface (111) on the rear end of the mounting bracket (11) to move the rear axle (32) backward in the elongated dropout (112) and has a front end, a rear end, a mounting hole (22), a connecting hole (21, 21A), an optional drive lip (23) and two optional chain tension bolts (24).

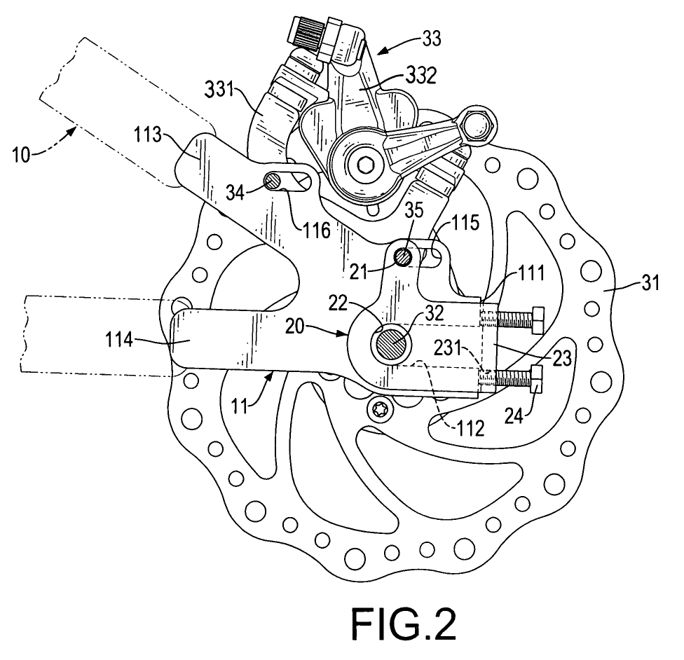

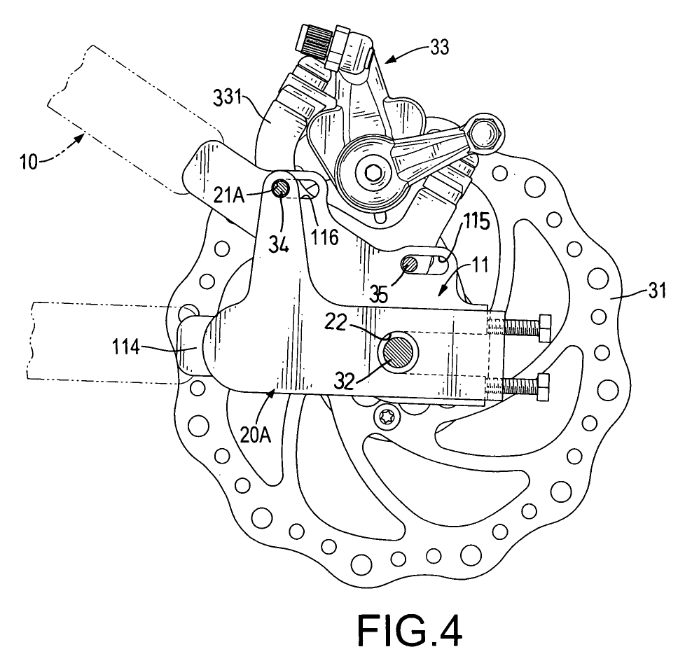

The mounting hole (22) is formed through the brake alignment device (20, 20A) and is mounted around the rear axle (32). In a first embodiment of the adjustable disc brake assembly in accordance with the present invention, the mounting hole (22) is formed near the front end of the brake alignment device (20) as shown in FIG. 2. In a second embodiment of the adjustable disc brake assembly in accordance with the present invention, the mounting hole (22) is formed near the rear end of the brake alignment device (20A) as shown in FIG. 4.

The connecting hole (21,21A) is formed through the brake alignment device (20, 20A) near the front end and above the mounting hole (22) and aligns with one of the elongated slots (115, 116). In the first embodiment of the adjustable disc brake assembly, the connecting hole (21) aligns with the lower elongated slot (115). In the second embodiment of the adjustable disc brake assembly, the connecting hole (21A) aligns with the upper elongated slot (116).

The drive lip (23) is formed on and protrudes perpendicularly in from the rear end of the brake alignment device (20, 20A), corresponds to the drive surface (111) of the mounting bracket (11) and has two threaded holes (231). The threaded holes (231) are formed through the drive lip (23) and correspond to the drive surface (111) of the mounting bracket (11) on opposite sides of the elongated dropout (112).

The chain tension bolts (24) screw respectively into the threaded holes (231) in the drive lip (23) and press against the drive surface (111) of the mounting bracket (11) to move the mounting bracket (11) and the axle (32) backward to tighten the chain.

The disc brake (30) is attached to the mounting bracket (11) and the rear wheel and has a caliper (33), two pistons, two brake pads and a rotor (31).

The caliper (33) is mounted on the inner surface of the mounting bracket (11) and has a connecting bracket (331), an upper bolt (34), a lower bolt (35) and an activating lever (332).

The connecting bracket (331) is mounted slidably on the inner surface of the mounting bracket (11) and has an outside surface, an upper connecting hole (3311) and a lower connecting hole (3312). The upper connecting hole (3311) is threaded, is formed in the outside surface of the connecting bracket (331) and corresponds to the upper elongated slot (116) in the mounting bracket (11). The lower connecting hole (3312) is threaded, is formed in the outside surface of the connecting bracket (331) and corresponds to the lower elongated slot (115) in the mounting bracket (11).

In the first embodiment of the adjustable disc brake assembly, the upper bolt (34) extends through the upper elongated slot (116) and screws into the upper connecting hole (3311) to hold the caliper (33) securely against the inner surface of the mounting bracket (11). In the second embodiment of the adjustable disc brake assembly, the upper bolt (34) further extends through the connecting hole (21A) to attach the brake alignment device (20A) securely to caliper (33) and slidably to the mounting bracket (11). The upper bolt (34) is loosened to adjust the position of the rear wheel and the caliper (33).

In the first embodiment of the adjustable disc brake assembly, the lower bolt (35) extends through the connecting hole (21) to attach the brake alignment device (20) securely to caliper (33) and slidably to the mounting bracket (11). The lower bolt (35) is loosened to adjust the position of the rear wheel and the caliper (33). In the second embodiment of the adjustable disc brake assembly, the lower bolt (35) only extends through the lower elongated slot (115) and screws into the lower connecting hole (3312) to hold the caliper (33) securely against the inner surface of the mounting bracket (11).

The activating lever (332) is connected pivotally to the connecting bracket (331) and activates the disc brake (30) when the activating lever (332) is pulled.

The pistons are mounted transversely and coaxially in the caliper (33) and extend toward each other when the activating lever (332) is pulled.

The brake pads are mounted respectively on the pistons in the caliper (33), face each other and are pushed toward each other when the pistons extend toward each other.

The rotor (31) is attached to the hub (37), is mounted rotatably around the rear axle (32) and between the brake pads and is squeezed by the brake pads to slow or stop rotation of the rotor (31).

The bicycle adjustable assembly as described has the following advantages.

1. The adjustable disc brake assembly maintains the relative position of the caliper (33) and the rotor (31) to maintain braking the position of the rear wheel is changed.

2. The adjustable disc brake assembly can accommodate changing the tension on the chain without causing the caliper (33) and rotor (31) to misalign. Therefore, braking efficiency is not degraded.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An adjustable disc brake assembly for a bicycle having a frame with an upper tube and a lower tube and a rear wheel with a rear axle, a hub mounted rotatably on the rear axle and having two ends and two axle nuts screwed respectively onto the ends of the rear axle, the adjustable disc brake assembly comprising
a mounting bracket being adapted to attach with the frame and hold one end of the rear axle and having
a front end;
a rear end;
an inner surface;
an outer surface;
an upper arm being formed on and protruding up at an angle up from the front end of the mounting bracket and being adapted to be attached securely to the upper tube of the frame;
a lower arm being formed on and protruding longitudinally from the front end of the mounting bracket below the upper arm and being adapted to be attached to the lower tube of the frame;
a drive surface being defined on the rear end of the mounting bracket;
an elongated dropout being formed horizontally through the drive surface of the mounting bracket, communicating with the rear end of the mounting bracket, being adapted to hold the rear axle and having
a closed front end; and
an open rear end;
a lower elongated slot being formed through the mounting bracket above and parallel to the elongated dropout; and
an upper elongated slot being formed through the upper arm parallel to the elongated dropout;
a brake alignment device being adapted to be mounted around the rear axle, abutting the outer surface of the mounting bracket and having
a front end;
a rear end;
a mounting hole being formed through the brake alignment device and being adapted to mount around the rear axle; and
a connecting hole being formed through the brake alignment device near the front end and above the mounting hole and aligning with one of the elongated slots; and
a disc brake being attached to the mounting bracket, being adapted to attach with the rear wheel and having
a caliper being mounted on the inner surface of the mounting bracket and having
a connecting bracket being mounted slidably on the inner surface of the mounting bracket and having
an outside surface;
an upper connecting hole being threaded, being formed in the outside surface of the connecting bracket and corresponding to the upper elongated slot in the mounting bracket; and
a lower connecting hole being threaded, being formed in the outside surface of the connecting bracket and corresponding to the lower elongated slot in the mounting bracket;
an upper bolt extending through the upper elongated slot and screwing into the upper connecting hole to hold the caliper securely against the inner surface of the mounting bracket;
a lower bolt extending through the lower elongated slot and screwing into the lower connecting hole to hold the caliper securely against the inner surface of the mounting bracket; and
an activating lever being connected pivotally to the connecting bracket and activating the disc brake when the activating lever is pulled; and
a rotor being attached to the hub and being adapted to mount rotatably around the rear axle.

2. The adjustable disc brake assembly as claimed in claim 1, wherein the brake alignment device further has
a drive lip formed on and protruding perpendicularly in from the rear end of the brake alignment device, corresponding to the drive surface of the mounting bracket and having two threaded holes formed through the drive lip and corresponding to the drive surface of the mounting bracket on opposite sides of the elongated dropout; and two chain tension bolts screwed respectively into the threaded holes in the drive lip and pressing against the drive surface of the mounting bracket.

3. The adjustable disc brake assembly as claimed in claim 1, wherein
the upper arm is rectangular; and
the lower arm is rectangular.

4. The adjustable disc brake assembly as claimed in claim 1, wherein
the mounting hole in the brake alignment device is formed near the front end of the brake alignment device; and
the connecting hole in the brake alignment device aligns with the lower elongated slot; and
the lower bolt extends through the connecting hole to attach the brake alignment device securely to caliper and slidably to the mounting bracket.

5. The adjustable disc brake assembly as claimed in claim 1, wherein
the mounting hole in the brake alignment device is formed near the rear end of the brake alignment device;
the connecting hole in the brake alignment device aligns with the upper elongated slot; and
the upper bolt extends through the connecting hole to attach the brake alignment device securely to caliper and slidably to the mounting bracket.

6. The adjustable disc brake assembly as claimed in claim 2, wherein
the upper arm is rectangular; and
the lower arm is rectangular.
